(19) United States
(12) Patent Application Publication
(10) Pub. No.: US 2018/0038278 A1
(43) Pub. Date: Feb. 8, 2018

(54) CONSTANT-VOLUME COMBUSTION SYSTEM FOR A TURBINE ENGINE OF AN AIRCRAFT ENGINE

(71) Applicant: SAFRAN HELICOPTER ENGINES, Bordes (FR)

(72) Inventors: Guillaume TALIERCIO, Rontignon (FR); Christophe Nicolas Henri VIGUIER, Arros de Nay (FR)

(73) Assignee: SAFRAN HELICOPTER ENGINES, Bordes (FR)

(21) Appl. No.: 15/551,419

(22) PCT Filed: Feb. 15, 2016
(86) PCT No.: PCT/FR2016/050337

§ 371 Date: Aug. 16, 2017

(30) Foreign Application Priority Data
Feb. 17, 2015 (FR) 15 51301

(51) Int. Cl. F02C 5/02; F23R 7/00; F02C 5/12

(52) U.S. Cl. CPC F02C 5/02; F02C 5/12; F23R 7/00

(57) ABSTRACT

A constant-volume combustion system is for a turbine engine. The system includes a plurality of combustion chambers regularly distributed around a longitudinal axis; a toroidal manifold including a radially oriented outlet for supplying compressed air, from a compressor, to each combustion chamber; a toroidal exhaust pipe including a radially oriented inlet for collecting the combustion gases from the combustion chambers, the combustion chambers being radially positioned between the outlet of the manifold and the inlet of the exhaust pipe; and a timing device for each chamber for drawing in compressed air from the outlet of the manifold and ejecting combustion gas towards the exhaust pipe.

### TECHNICAL FIELD

The invention relates to a constant-volume combustion system, also designated by the acronym CVC, or by the term combustion according to the Humphrey cycle, this system being intended to equip a turbomachine of an aircraft engine.

### STATE OF PRIOR ART

The combustion chamber of most of the current aircraft engines, of the turbojet engine type, operates according to the Brayton cycle which is a constant pressure continuous combustion cycle.

However, it is known that the replacement of a constant pressure combustion system by a constant-volume combustion system, that is implementing the Humphrey cycle, should bring about a specific consumption gain that can reach up to twenty percents.

Generally, the Humphrey cycle imposes to preserve the load in a physically closed volume for some part of the cycle, and it induces the implementation of a pulsed type operating region.

In practice, a constant-volume combustion aircraft engine includes a compressor, an exhaust pipe and a combustion chamber connected to the compressor and to the pipe, by respectively injection and ejection valves.

Each constant-volume combustion cycle includes a phase of intake and setting in the combustion chamber of a compressed air and fuel mixture, a phase of ignition by a controlled system and combustion of the mixture, and a phase of expansion and ejection of the combustion gas.

Valves are controlled in a synchronised manner to implement these three phases of the Humphrey cycle: they are in particular all closed during the combustion phase, after which the opening of the ejection valve(s) allows the expansion and ejection of the combustion gases.

In known constant-volume combustion systems, it has been attempted to date to reduce the general bulk of the system, in particular to integrate it in the thickness of the aircraft wing.

The object of the invention is on the contrary to provide a constant-volume combustion system architecture that can be simply integrated to a current turbomachine architecture, having a generally cylindrical shape and with a large diameter.

### DISCLOSURE OF THE INVENTION

One object of the invention is a constant-volume combustion system for an aircraft turbomachine, this system comprising:
several combustion chambers evenly distributed about a longitudinal axis;
a compressed air manifold extending about the longitudinal axis and comprising a radially oriented compressed air outlet for supplying compressed air from a compressor of the turbomachine, to each combustion chamber;
an exhaust pipe extending about the longitudinal axis and comprising a radially oriented inlet to receive the combustion gases from the combustion chambers as well as an axially oriented outlet, the combustion chambers being radially interposed between the outlet of the manifold and the inlet of the exhaust pipe;
timing means for timing the intake into each combustion chamber of compressed air from the outlet of the manifold and the ejection out of each combustion chamber of combustion gases to the exhaust pipe.

With this arrangement, the combustion system radially extends on a small length along the longitudinal axis, which facilitates its integration to a current turbomachine, where it can be installed in place of a continuous combustion chamber, namely between the compression stages and the turbine stages.

The invention also relates to a combustion system thus defined, comprising a combustion body carrying the combustion chambers, this combustion body including at each combustion chamber, a radially oriented compressed air intake aperture, and a radially oriented combustion gas exhaust aperture, and a rotary feeder with means for rotatably driving this rotary feeder, this rotary feeder including:
an intake ring coaxial with the longitudinal axis and provided with intake ports, this intake crown being radially interposed between the outlet of the manifold and the combustion body;
an exhaust ring coaxial with the longitudinal axis and provided with exhaust ports, this exhaust ring being radially interposed between the inlet of the exhaust pipe and the combustion body.

The invention also relates to a combustion system thus defined, wherein the outlet of the manifold extends about the combustion chambers and wherein the combustion chambers are located about the inlet of the exhaust pipe.

The invention also relates to a combustion system thus defined, wherein the inlet of the exhaust pipe extends about the combustion chambers, and wherein the combustion chambers are located about the outlet of the manifold.

The invention also relates to a combustion system thus defined, wherein each combustion chamber includes an intake port and an exhaust port, and wherein each combustion chamber is rotatably mounted about an axis which is central to the same to be rotatable on itself, means for rotatably driving the combustion chambers, each intake port allowing intake of compressed air into the chamber when this port is facing the outlet of the compressed air manifold, each exhaust port allowing exhaust of combustion gases out of the combustion chamber when this exhaust port is facing the inlet of the exhaust pipe.

The invention also relates to a combustion system thus defined, wherein the means for rotatably driving each combustion chamber comprise a toothed wheel rotatably driven about the longitudinal axis and for each combustion chamber, a pinion meshed with this toothed wheel by being radially spaced apart from the longitudinal axis, each pinion being rigidly coupled to a corresponding combustion chamber.

The invention also relates to a turbomachine comprising a constant-volume combustion system thus defined.

The invention also relates to a turbojet engine type aircraft engine comprising a turbomachine thus defined.

### BRIEF DESCRIPTION OF THE DRAWINGS

FIG. 1 is a schematic side cross-section view of a first embodiment of the system according to the invention comprising a fixed combustion chamber and which is integrated to an engine with a centrifugal compressor;

FIG. 2 is a transverse cross-section view showing the arrangement of the combustion chambers for the first or the second embodiment of the invention;

FIG. 3 is a close-up view showing the arrangement of the intake and ejection ports in the first embodiment of the invention;

FIG. 4 is a partial schematic side cross-section view of a second embodiment of a system according to the invention also comprising a fixed combustion chamber and which is integrated to an engine with an axial compressor;

FIG. 5 is a partial schematic side cross-section view of a third embodiment of the system according to the invention comprising a rotary combustion chamber and which is integrated to an engine with a centrifugal compressor.

### DETAILED DISCLOSURE OF PARTICULAR EMBODIMENTS

Generally, the invention is applicable to a turbomachine comprising a compressor that can be centrifugal or even axial, and a turbine that can be radial or even axial.

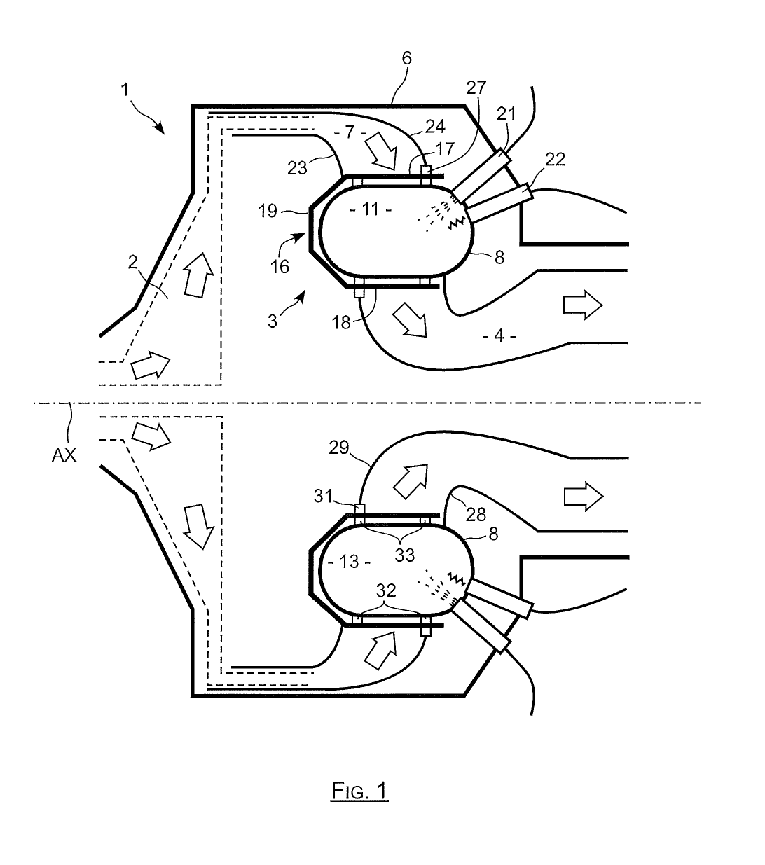

In FIG. 1, an engine 1 equipped with the constant-volume combustion system according to the invention has a general structure of a revolution about a main axis AX which corresponds to its longitudinal axis.

This engine includes upstream thereof a compressor 2 which is herein a centrifugal compressor, to supply a constant-volume combustion system generally designated by reference 3, ejecting combustion gases at the inlet of an exhaust pipe 4 which is located downstream of this combustion system.

The compressor 2, the combustion system 3 and the exhaust pipe 4 have themselves revolution structures while being located behind each other along the axis AX, being surrounded as a whole by a revolution case 6 represented symbolically.

The centrifugal compressor 2 is supplied with air from upstream of the engine and which is conveyed in parallel to the longitudinal axis. When this air has passed through the centrifugal compressor, it is radially ejected along a centrifugal direction, that is moving away from the axis AX, to be received at the inlet of a manifold 7 in which it first travels longitudinally to downstream of the engine. By continuing its travel in this manifold 7, the air is then radially directed along a radial direction, that is to the axis AX, to exit from the manifold 7 in order to enter the combustion system 3 itself.

After they have been burned in the constant-volume combustion system 3, the combustion gases are ejected from this system 3 radially along a radial direction by being taken in at the inlet of the exhaust pipe 4. During their travel in this exhaust pipe, the gases are adjusted to be expanded in parallel to the axis AX. This expansion can, according to the architecture retained, be used to directly generate a thrust, or even drive a turbine not represented which is located downstream of the exhaust pipe 4.

As visible in FIG. 1, the combustion system 3 itself has a general toric structure. This system is surrounded by the outlet of the manifold 7, and it surrounds the inlet of the exhaust pipe 4, while being located along the axis AX at the same level as the outlet of the manifold 7 and as the inlet of the exhaust pipe 4.

This combustion system 3 includes a fixed combustion body 8 having here four combustion chambers 11-14 evenly spaced apart from each other about the axis AX.

Each combustion chamber 11-14 is a closed enclosure delimited by one or more walls, but including an intake aperture 11a-14a at its outer peripheral face, and an ejection aperture 11e-14e at its inner peripheral face.

The intake apertures 11a-14a enable the compressed air from the outlet of the manifold 7 to be taken in the chambers 11-14, whereas the ejection apertures enable the combustion gases to be discharged to the inlet of the exhaust pipe. These intakes and ejections occur in an independent and coordinated manner for each of the chambers 11a-14a of the combustion body.

The gas intakes and ejections are insured and synchronised by a rotary feeder 16 which comprises an intake ring 17 surrounding the combustion body 8 by running along its outer face, and an ejection ring 18 running along the inner face of the combustion body 8 by being surrounded by the same.

The intake ring 17 and the ejection ring 18 each have a truncated cylinder shape, centred on the axis AX, and they join each other at a bottom 19 of the feeder 16. This rotary feeder 16 thus has generally a U-shaped cross-section toric gutter shape which covers the upstream, inner and outer faces of the combustion body 8.

The intake ring 17 surrounds the combustion body 8 by being interposed between this combustion body 8 and the outlet of the manifold 7. In an analogous way, the ejection ring 18 is surrounded by the combustion body 8 by being interposed between this body and the inlet of the exhaust pipe 4.

As visible in FIG. 3, the intake wall 17 includes a series of four intake apertures or ports referred to as 17a, evenly distributed along this intake wall, that is evenly distributed about the axis AX.

In the same manner, the ejection wall 18 includes four ejection apertures or ports 18e evenly distributed along this wall, that is about the axis of revolution AX.

In use, the feeder 16 is rotatably driven about the axis AX, to sequence gas intakes and ejections for the different chambers.

More particularly, when a port 17a of the feeder 16 is at least partially facing the intake aperture 11a of the window 11, compressed air from the compressor is taken in the chamber 11 via the outlet of the manifold 7.

Since the feeder 16 continues rotating, the port 17a spaces apart from the intake aperture 11a until the latter is closed. Under this situation, the ejection aperture 11e is also closed by the ejection wall 18, such that fuel can be injected into the chamber 11 via an injector 21 visible in FIG. 1. After the fuel is injected, the combustion in the closed chamber is triggered by a plug 22, or any other controlled ignition system.

Since the feeder 16 continues rotating, about the axis AX, an ejection port 18e comes to face the ejection aperture 11e of the chamber 11, which enables the combustion gases to be ejected into the exhaust pipe 4 via its inlet, to produce a thrust or supply a turbine.

Since the feeder 16 continues rotating, a new window 17a comes in registry with the intake aperture 11a, which enables a new compressed air intake to be started.

It is to be noted that during the start of the compressed air intake, the gas ejection is still open because there is an overlapping portion during which the intake and the ejection ports are simultaneously open. This overlapping enables the combustion gases to be flushed.

On the other hand, the cycle just described for the combustion chamber 11 happens in the same way for the other chambers, that is chambers 12-14.

As visible in FIG. 1, the manifold 7 is delimited by two revolution walls, namely an inner wall 23 and an outer wall 24, the inner space of this manifold thus having a generally toric-shape centred on the axis AX. The inner wall 23 can be fixed, or be rigidly integral with the rotary feeder 16 to rotate with the same, as is the case in the example of FIG. 1.

The outer wall 24 is here fixed by being for example rigidly fastened to the case 6. It includes an inner peripheral edge, located facing the ring for supplying the feeder 16 which is on the contrary rotating. A circular sealing means 27 is interposed between the inner edge of the outer wall 24 and the outer face of the supply wall 17 in order to insure a satisfactory sealing at this junction, when the feeder 16 rotates relative to the inner edge of the outer wall 24, that is when the engine is in use.

The exhaust pipe 4 is itself delimited by an outer revolution wall 28 and an inner revolution wall 29, this pipe 4 having itself a toric architecture about the longitudinal axis AX.

The inner wall 29 is here fixed. It includes an outer peripheral edge which is located facing the ejection ring 18 along which it runs. A sealing means 31 is interposed between this outer edge and the inner face of the ejection ring 18 to insure a satisfactory sealing of the junction of these two elements when the rotary feeder rotates, that is when the engine is in use.

The outer wall 28 which is also fixed includes an outer peripheral edge which is rigidly fastened to an internal portion of the combustion body 8 which is also fixed.

The sealing of the rotary feeder with the combustion body is also optimised by four circular sealing means.

Two circular sealing means 32 are interposed between the inner face of the intake ring 17 which is rotary and the outer face of the combustion body 8 which is fixed, by being disposed on either side of the intake ports 17a and the intake apertures 11a-14a along the longitudinal axis AX. Both these means aim at limiting, or even cancelling, the amount of air taken in by an intake port 17a which leaks before reaching the corresponded intake aperture.

Analogously, two other circular sealing means 33 are also interposed between the outer face of the ejection ring 18 which is rotary and the inner face of the combustion body 8 which is fixed, by being disposed on either side of the ejection ports 18e and the ejection apertures 11e-14e along the longitudinal axis AX.

According to the invention, the compressed air and combustion gas stream passing through the combustion chambers is moving radially, that is perpendicularly to the axis AX.

In the example of FIG. 1, this stream is radial, that is it is directed to the axis, which is appropriate for an architecture with a centrifugal compressor, that is delivering a compressed air radial stream remotely from the axis, this stream being also possibly deviated to be redirected to the axis for the combustion thereof.

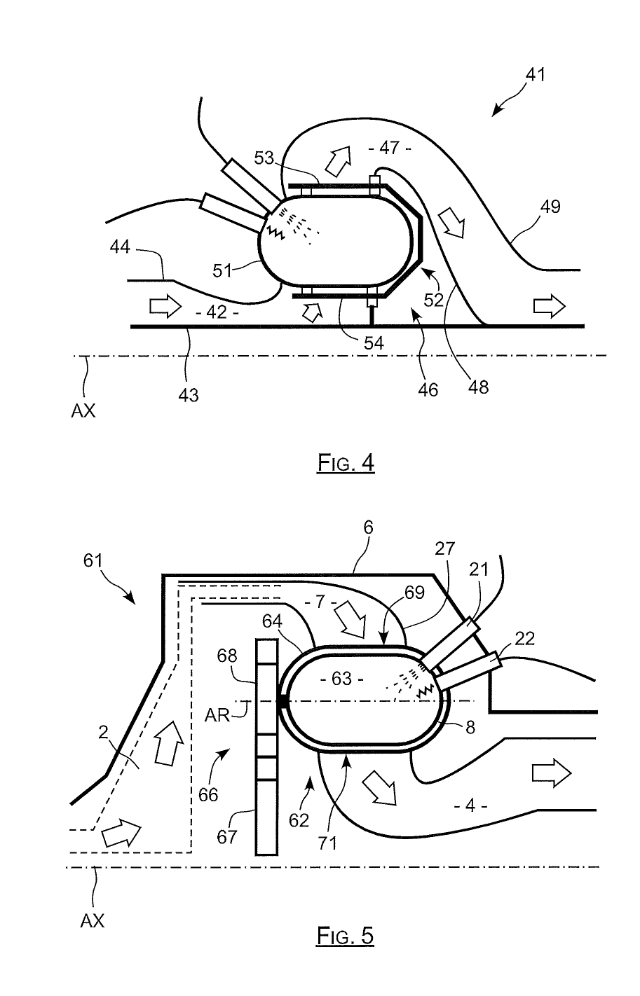

The invention is also applicable to an axial compressor engine architecture, as in the example of FIG. 4, wherein the stream passes through the combustion chambers by being oriented in a centrifugal manner, unlike the case of FIG. 1.

In the example of FIG. 4, the engine, referred to as 41 includes an axial compressor, not represented, which delivers compressed air in an axial manifold 42 delimited by an cylindrical inner wall 43 and an outer revolution wall 44 both of which are fixed.

The compressed air first travels longitudinally in this manifold 42 to be then radially deviated therein in order to exit from this manifold by following a centrifugal radial direction, so as to enter the constant-volume combustion system 46 which surrounds the outlet of this manifold 42.

The combustion gases are then radially ejected from the system 46 along a radial direction to come to the inlet of an exhaust pipe 47 which is also delimited by an inner revolution wall 48 and an outer revolution wall 49. This exhaust pipe has a toric shape the inlet of which surrounds the combustion system 46, and its inner wall as well as its outer wall are both fixed.

The trajectory of the combustion gases which are taken radially in this exhaust pipe 47 is adjusted in order that they travel longitudinally, so that these gases are expanded along the direction AX so as to be able to supply a turbine not represented or to generate directly a longitudinally oriented thrust.

The constant-volume combustion system 46 is quite analogous to the combustion system 3 of the example of FIGS. 1 and 3. It includes a combustion body 51 which is identical to the combustion body 8, and which comprises several combustion chambers evenly distributed about the axis AX.

The gas intake and ejection is once again synchronised by a rotary feeder 52 which is analogous to the feeder 16 of the example of FIG. 1, this feeder having also a U-shaped cross-section toric gutter shape which partially covers the combustion body.

But, the feeder 52 is herein oriented upstream, in opposition to that of FIG. 1, that is it covers the downstream face of the combustion body, as well as the outer and inner peripheral faces of this body.

This rotary feeder 52 includes also an outer ring, referred to as 53 as well as an inner ring referred to as 54 which it is also cylindrical. Thus, the general structure of the feeder 52 is identical to that of the feeder 16, but it is its inner ring 54 which is equipped with intake ports to make up the intake ring, and it is its outer ring 53 which is provided with ejection ports to make up the exhaust ring.

Analogously, the intake apertures are located at the inner cylindrical wall of the combustion body 51, and the ejection apertures are formed at the outer wall of this combustion body 51.

The operation of this other engine 41 is analogous to that of the engine 1: the intakes and exhausts being synchronised here again by a circular rotary feeder which surrounds the combustion body, but the gases taken in and ejected follow here a trajectory which is centrifugal instead of being radial.

The sealing of the rotary feeder 52 with le combustion body 51 is here again optimised by four circular sealing means.

Two circular sealing means are interposed between the outer face of the rotary intake ring and the inner face of the fixed combustion body, by being disposed on either side of the intake ports and apertures along the axis AX. Both means aim at limiting, or even cancelling, the amount of air taken in by an intake port which leaks before reaching the corresponding intake aperture.

Analogously, two other circular sealing means are interposed between the inner face of the rotary ejection ring and the outer face of the fixed combustion body, by being disposed along the axis AX on either side of the ejection ports and apertures.

In a complementary fashion, a circular sealing means is interposed between the outer edge of the inner wall 43 of the manifold 42 and the inner face of the supply ring in order to ensure a satisfactory sealing for this junction, when the feeder rotates.

Another circular sealing means is interposed between the inner edge of the inner wall 48 of the exhaust pipe 47 and the outer face of the ejection ring to ensure a sealing of the junction of both these elements when the rotary feeder rotates.

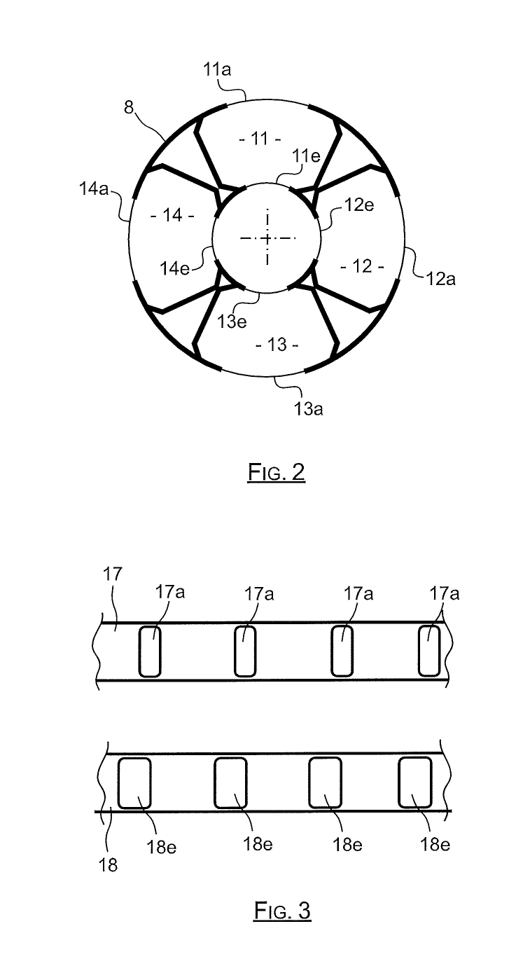

In the embodiment of FIGS. 1 to 4, the combustion body is fixed, and it is a rotary feeder which synchronises the intakes and exhausts for each combustion chamber, these intakes and exhausts occurring along radially oriented trajectories.

But the invention also relates to an architecture in which each combustion chamber is provided rotary and rotatably driven to synchronise the air intakes and combustion gas exhausts.

It is the case in the example of FIG. 5 where this solution is applied to an engine 61 provided with a compressor which is centrifugal, this engine 61 thus having a general structure identical to that of the engine of FIG. 1.

This engine which appears in FIG. 5 comprises much like that of FIG. 1, a centrifugal compressor 2 upstream thereof to supply a constant-volume combustion system 62 which ejects combustion gases at the inlet of the downstream exhaust pipe 4.

The compressor 2, the combustion system 62 and the exhaust pipe 4 have themselves revolution structures while being distributed behind each other along the axis AX, being surrounded as a whole by a case 6.

The compressor 2 delivers air it radially ejects along a centrifugal direction, this being received at the inlet of the manifold 7 in which it first travels longitudinally to downstream before being radially adjusted along a radial direction at the outlet of the manifold 7 to enter the system 62.

After being burned in the system 62, the gases are radially ejected along a radial direction to be taken in at the inlet of the exhaust pipe 4 in which they are then adjusted to be expanded in parallel to the axis AX.

The combustion system 62 houses in a general toric structure which is surrounded by the outlet of the manifold 7 and which surrounds the inlet of the exhaust pipe 4, while being located along the axis AX at the same level as the outlet of the manifold 7 and as the inlet, the pipe 4.

The constant-volume combustion system includes here again several distinct combustion chambers, for example four in number, which are evenly distributed about the axis AX, one of these chambers appearing in the Fig. by being referred to as 63.

This combustion chamber 63 is surrounded by a fixed outer jacket 64 in which there are rotatably mounted so as to be able to pivot about a longitudinal axis of rotation AR which is radially spaced from the axis AX.

The engine is still equipped with means for rotatably driving each inner shroud of the combustion chamber. These driven means are here a gear train 66 comprising for example a main wheel 67 with a large diameter centred on the axis AX, and for each combustion chamber, a pinion 68 driven by this main wheel and itself driving the combustion chamber to which it is mated by being for example rigidly fastened thereto.

The fixed jacket 64 includes an intake aperture 69 which is located at the region of this jacket which is the farthest from the axis of revolution AX, this aperture being thus facing the outlet of the manifold 7. Analogously, this fixed jacket 64 also includes an ejection aperture 71 which is on the contrary located at the closest region thereof to the axis AX, to directly open into the inlet of the exhaust pipe 4. The intake and exhaust apertures are advantageously spaced apart from each other along the axis AX.

In a complementary fashion, the rotary combustion chamber 63 includes an intake port and an exhaust port, respectively located along the axis AX, at the intake aperture 69, and at the ejection aperture 71. These ports can be spaced apart from each other about the axis AR so as to optimise timing of the compressed air intakes and combustion gas ejection.

Thus, during the rotation of the combustion chamber 63 about its axis AR, when the intake port is facing the aperture 69, compressed air is taken in the chamber, from the outlet of the manifold 7. When the intake port is no longer facing the aperture 69, the chamber 63 is completely closed, which enables fuel to be injected and combustion to be caused by a controlled ignition, implementing for example a plug.

Then, the rotational movement of the chamber 63 results in a situation in which the ejection port is located facing the exhaust aperture 71, which enables the combustion gases to be ejected into the inlet of the exhaust pipe 4 to be expanded in order to drive a turbine or to generate a thrust.

The intake and exhaust ports can be located at the same level about the axis AR by being spaced apart from each other along this axis, such that when the intake port is facing the aperture 69, the exhaust port is sealed by the rest of the jacket. In the same manner, when the exhaust port is facing the aperture 71, the intake port is sealed by the rest of the jacket in this region. In this case, the intake and exhaust apertures are then also spaced apart from each other along the axis AX by an appropriate value.

As will be understood, the other combustion chambers have the same operation as the chamber 63, which enables these different chambers to deliver combustion gases at the inlet of the exhaust pipe 4.

In the example that has been described, the invention is applied to a turbomachine of an aircraft engine, but the invention is applicable as well to a turbomachine being part of a different equipment, such as in particular a terrestrial electrical power generation equipment or else.

1. A constant-volume combustion system for a turbomachine, this system comprising:
several combustion chambers evenly distributed about a longitudinal axis;
a compressed air manifold extending about the longitudinal axis and comprising a radially oriented compressed air outlet for supplying compressed air, from a compressor of the turbomachine, to each combustion chamber;
an exhaust pipe extending about the longitudinal axis and comprising a radially oriented inlet to receive the combustion gases from the combustion chambers as well as an axially oriented outlet, the combustion chambers being radially interposed between the outlet of the manifold and the inlet of the exhaust pipe;
timing means for timing the intake into each combustion chamber of compressed air from the outlet of the manifold and the ejection out of each combustion chamber of combustion gases to the exhaust pipe.

2. The system according to claim 1, further comprising a combustion body carrying the combustion chambers, this combustion body including at each combustion chamber, a radially oriented compressed air intake aperture, and a radially oriented combustion gas exhaust aperture, and a rotary feeder with means for rotatably driving this rotary feeder, this rotary feeder including:
an intake ring coaxial with the longitudinal axis and provided with intake ports, this intake crown ring being radially interposed between the outlet of the manifold and the combustion body;
an exhaust ring coaxial with the longitudinal axis and provided with exhaust ports, this exhaust ring being radially interposed between the inlet of the exhaust pipe and the combustion body.

3. The system according to claim 1, wherein the outlet of the manifold extends about the combustion chambers and wherein the combustion chambers are located about the inlet of the exhaust pipe.

4. The system according to claim 1, wherein the inlet of the exhaust pipe extends about the combustion chambers, and wherein the combustion chambers are located about the outlet of the manifold.

5. The system according to claim 1, wherein each combustion chamber includes an intake port and an exhaust port, and wherein each combustion chamber is rotatably mounted about an axis which is central to the same to be rotatable on itself, means for rotatably driving the combustion chambers, each intake port allowing intake of compressed air into the chamber when this port is facing the outlet of the compressed air manifold, each exhaust port allowing exhaust of combustion gases out of the combustion chamber when this exhaust port is facing the inlet of the exhaust pipe.

6. The system according to claim 5, wherein the means for rotatably driving each combustion chamber comprise a toothed wheel rotatably driven about the longitudinal axis and for each combustion chamber, a pinion meshed with this toothed wheel by being radially spaced apart from the longitudinal axis, each pinion being rigidly coupled to a corresponding combustion chamber.

7. A turbomachine comprising a constant-volume combustion system according to claim 1.

8. An aircraft engine comprising a turbomachine according to claim 7.
